(19) United States
(12) Patent Application Publication
(10) Pub. No.: US 2013/0027585 A1
(43) Pub. Date: Jan. 31, 2013

(54) Zoom Lens, Imaging Optical Device, and Digital Apparatus

(71) Applicant: Yoshihito SOUMA, Sakai-shi (JP)

(72) Inventor: Yoshihito SOUMA, Sakai-shi (JP)

(73) Assignee: Konica Minolta Advanced Layers, Inc., Tokyo (JP)

(21) Appl. No.: 13/542,871

(22) Filed: Jul. 6, 2012

(30) Foreign Application Priority Data
Jul. 6, 2011 (JP) 2011-150360

(51) Int. Cl. G02B 15/177; H04N 5/262

(52) U.S. Cl. 348/240.1; 359/680; 348/E05.055

(57) ABSTRACT

A first lens unit having negative power, a second lens unit having positive power, a third lens unit having negative power, and a fourth lens unit having positive power are disposed in this order from an object side. At least the first lens unit to the third lens unit move to change intervals between lens units so that magnification is varied. The second lens unit has at least one air interval inside and is split into two lens units with a boundary of an air interval closest to an image side in the second lens unit, which includes a second-a lens unit on the object side and a second-b lens unit on the image side, and the second-b lens unit is moved in a plane substantially perpendicular to an optical axis for damping vibrations.

### CROSS-REFERENCE TO RELATED APPLICATIONS

This application is based on Japanese Patent Application No. 2011-150360 filed on Jul. 6, 2011, the contents of which are hereby incorporated by reference.

### BACKGROUND OF THE INVENTION

1. Field of the Invention

The present invention relates to a zoom lens, an imaging optical device, and a digital apparatus. For instance, the present invention relates to a compact zoom lens suitable for a digital apparatus with image input function (such as a digital camera) for acquiring an image of a subject with an image sensor, to an imaging optical device that outputs an image of a subject acquired by the zoom lens and the image sensor as an electrical signal, and to the digital apparatus with image input function including the imaging optical device.

2. Description of Related Art

A negative, positive, negative, and positive zoom type has a structure in which negative first lens unit and a negative third lens unit are disposed symmetrically with respect to an aperture stop, and hence off-axial aberration can be corrected easily. In addition, the entire optical length at the telephoto end can be shortened easily by a telephoto effect of the negative third lens unit at a telephoto end. Therefore, this zoom type is a lens type suitable for an approximately three times zoom lens having relatively wide angle focal length of 2ω≦75 (degrees). For instance, there is known an interchangeable lens described in Patent Document 1, and there is known a lens for a camera with an integral lens described in Patent Document 2 or Patent Document 3.
Patent Document 1: JP-A-2010-170061
Patent Document 2: JP-A-2006-208889
Patent Document 3: JP-A-2010-152148

The zoom lens described in Patent Document 1 has a structure in which a positive second lens unit and a positive fourth lens unit move largely to an object side when magnification is varied from a wide angle end to a telephoto end. Therefore, it is difficult to reduce the entire optical length at the telephoto end.

The zoom lens described in Patent Document 2 or Patent Document 3 has a structure in which a position of the fourth lens unit does not change when the magnification is varied from the wide angle end to the telephoto end. The magnification is varied mainly by changing an interval between the first lens unit and the second lens unit. In this structure, a third lens unit is used as the focus lens unit, and hence a focus movement direction is toward the image side. Therefore, at the telephoto end in which particularly large focus movement is required, a space between the third lens unit and the fourth lens unit can be effectively used so that the entire optical length can be reduced.

However, the zoom lens described in Patent Document 2 or 3 has a problem that there is no lens unit suitable for damping vibrations. For instance, if the first lens unit is used for damping vibrations, the lens diameter becomes large, and the weight is increased. Therefore, the first lens unit is not suitable for damping vibrations. In general, if the second lens unit is used for damping vibrations in the negative, positive, negative, and positive zoom type, damping sensitivity is apt to be too high. Therefore, the second lens unit is not suitable for damping vibrations. If the damping sensitivity becomes too high, image quality is apt to be deteriorated when a position of the damping lens unit varies due to electrical noise or the like during exposure period. In addition, in order to reduce the entire optical length, the damping sensitivity is apt to be higher. Because the third lens unit is a focus lens unit, if the third lens unit is used for damping vibrations, a structure of a drive mechanism used for damping vibrations and focusing becomes complicated. Therefore, the third lens unit is not suitable for damping vibrations. If the fourth lens unit is used for damping vibrations, the damping sensitivity is apt to be too low. Therefore, there is a problem that a high speed driving device and a large drive range are necessary.

### SUMMARY OF THE INVENTION

The present invention is made in view of the above-mentioned problem, and it is an object thereof to provide a zoom lens having a zoom ratio of approximately three times including relatively wide angle focal length range with an angle of view (2ω) of 75 degrees or larger, in which the entire optical length is reduced, and high optical performance in damping vibrations is obtained, and to provide an imaging optical device as well as a digital apparatus including the zoom lens.

In order to achieve the above-mentioned object, a zoom lens according to a first aspect of the present invention includes, in order from an object side, a first lens unit having negative power, a second lens unit having positive power, a third lens unit having negative power, and a fourth lens unit having positive power. At least the first lens unit to the third lens unit move to change intervals between lens units so that magnification is varied. The second lens unit has at least one air interval inside and is split into two lens units with a boundary of an air interval closest to an image side in the second lens unit, which includes a second-a lens unit on the object side and a second-b lens unit on the image side, and the second-b lens unit is moved in a plane substantially perpendicular to an optical axis for damping vibrations.

### BRIEF DESCRIPTION OF THE DRAWINGS

FIGS. 1A, 1B, and 1C are optical configuration diagrams of a first embodiment (Example 1).

FIGS. 2A, 2B, and 2C are optical configuration diagrams of a second embodiment (Example 2).

FIGS. 3A, 3B, and 3C are optical configuration diagrams of a third embodiment (Example 3).

FIGS. 4A to 4I are vertical aberration diagrams of Example 1.

FIGS. 5A to 5I are vertical aberration diagrams of Example 2.

FIGS. 6A to 6I are vertical aberration diagrams of Example 3.

FIGS. 7A to 7E are lateral aberration diagrams at a wide angle end before and after camera shake correction in Example 1.

FIGS. 8A to 8E are lateral aberration diagrams at a telephoto end before and after camera shake correction in Example 1.

FIGS. 9A to 9E are lateral aberration diagrams at a wide angle end before and after camera shake correction in Example 2.

FIGS. 10A to 10E are lateral aberration diagrams at a telephoto end before and after camera shake correction in Example 2.

FIGS. 11A to 11E are lateral aberration diagrams at a wide angle end before and after camera shake correction in Example 3.

FIGS. 12A to 12E are lateral aberration diagrams at a telephoto end before and after camera shake correction in Example 3.

FIG. 13 is a schematic diagram illustrating a general structure example of a digital apparatus equipped with an imaging optical device.

### DETAILED DESCRIPTION OF THE PREFERRED EMBODIMENTS

Hereinafter, a zoom lens, an imaging optical device, and a digital apparatus according to the present invention are described. The zoom lens according to the present invention includes, in order from the object side, a first lens unit having negative power, a second lens unit having positive power, a third lens unit having negative power, and a fourth lens unit having positive power (power is a quantity defined as the reciprocal of a focal length). At least the first lens unit to the third lens unit move to change intervals between lens units so that magnification is varied. The second lens unit has at least one air interval inside and is split into two lens units with a boundary of an air interval closest to an image side in the second lens unit. The lens units on the object side and on the image side are referred to as a second-a lens unit and a second-b lens unit, respectively. Then, the second-b lens unit is moved in a plane substantially perpendicular to an optical axis for damping vibrations (namely, for camera shake correction).

In general, in a negative, positive, negative, and positive zoom type, axial ray height becomes highest in the second lens unit, and as a result, sensitivity of deterioration of imaging performance due to decentering of each lens constituting the second lens unit becomes high. Therefore, when the lens unit is assembled, adjustment of axes of lenses constituting the lens unit is often performed. On the other hand, because the damping lens unit tilts the optical axis by its decentering, it is designed so that sensitivity of image quality deterioration due to decentering (for example, decentering coma aberration sensitivity or partial blur sensitivity) becomes as small as possible.

If the damping lens unit is positioned inside the second lens unit, it is necessary to maintain an accuracy of the optical axis adjustment between elements on the object side and on the image side of the damping lens unit. However, because there is a mechanism for damping vibrations, it is difficult to secure the accuracy. Therefore, it is desirable to dispose the damping lens unit closest to the object side or the image side in the second lens unit, in order to suppress deterioration of imaging performance due to assembly error. However, the place closest to the object side in the second lens unit is a place where the axial ray height becomes highest in the optical system, and so it is difficult to suppress the decentering sensitivity of the damping lens unit itself. In view of the above-mentioned point, it is desirable to use the lens unit including the lens disposed closest to the image side in the second lens unit (namely, the second-b lens unit) as the damping lens unit.

According to the above-mentioned characteristic structure, it is possible to realize a zoom lens having a zoom ratio of approximately three times including a relatively wide angle focal length range with an angle of view (2ω) of 75 degrees or larger in which reduction of the entire optical length and high optical performance in damping vibrations are achieved, and to realize an imaging optical device including the zoom lens. By using the zoom lens or the imaging optical device for a digital apparatus such as a digital camera, it is possible to add high performance image input function to the digital apparatus in a lightweight and compact manner. Therefore, it is possible to contribute to a smaller size, lower cost, higher performance, and higher function of the digital apparatus. In addition, the zoom lens according to the present invention is suitable as an interchangeable lens for a mirrorless type digital camera so as to achieve smaller lens back or larger diameter. Therefore, it is possible to realize a compact interchangeable lens that is convenient to carry. Conditions for obtaining these effects in good balance and further achieving high optical performance and a smaller size are described below.

As described above, if the second-b lens unit including the final lens in the second lens unit is used as the damping lens unit, it is easy to set appropriate damping sensitivity. In addition, as for the damping sensitivity, it is desirable to satisfy the following conditional expression (1).

−0.1<β2b<0.8 (1)

Here, β2b denotes a paraxial lateral magnification of the second-b lens unit at the telephoto end.

The damping sensitivity at the telephoto end is given by the following expression (BS).

(1−β2b)βr . . . (BS)

Here, βr denotes paraxial lateral magnification of a lens unit on the image side of the damping lens unit (namely, the third lens unit and the fourth lens unit) on the telephoto end.

The expression (BS) expresses sensitivity of movement of an image by shaking. For instance, if the image moves 1 mm on the image plane when the damping lens unit moves 1 mm, the damping sensitivity is one. If the paraxial lateral magnification β2b is large, the damping sensitivity (1−β2b)βr becomes small, and hence it is necessary to move the damping lens unit largely. As a result, it is necessary to ensure a large space for the damping lens unit to move, and hence an actuator having a large power is necessary. On the contrary, if the paraxial lateral magnification β2b is small, the damping sensitivity (1−β2b)βr becomes large, and hence is apt to be affected by noise or the like. As a result, image quality is deteriorated. From this viewpoint, it is preferred that the damping sensitivity (1−β2b)βr should be 1 to 2.

If the lower limit of the conditional expression (1) is lowered, the damping sensitivity becomes too high. Therefore, as understood from the expression (BS), it is necessary to decrease the magnification after the third lens unit. As a result, the entire optical length is increased at the telephoto end. If the upper limit of the conditional expression (1) is exceeded, the damping sensitivity becomes too low. Therefore, it is necessary to increase the magnification after the third lens unit. As a result, it is necessary to increase power of the third lens unit. Therefore, field curvature or coma aberration generated in the third lens unit is increased. Therefore, by satisfying the conditional expression (1), it is possible to achieve smaller size and higher performance in good balance.

It is more preferred to satisfy the following conditional expression (1a).

0.1<β2b<0.6 (1a)

This conditional expression (1a) defines a more preferable conditional range based on the above-mentioned viewpoint or the like in the conditional range defined by the conditional expression (1). Therefore, it is preferred to satisfy the conditional expression (1a) so that the above-mentioned effect can be more enhanced.

It is desirable to satisfy the following conditional expression (2).

0.6<H2b/H2<0.85 (2)

Here, H2 denotes the axial ray height at the telephoto end of the lens plane closest to the object side in the second lens unit, and H2b denotes the axial ray height at the telephoto end of the lens plane closest to the object side in the second-b lens unit.

In order to suppress the decentering coma aberration in damping vibrations, it is desirable to set the height of the axial ray entering the damping lens unit to be as low as possible. By disposing the damping lens unit closest to the image side in the second lens unit, it is possible to control the axial ray height to be as low as possible. In this case, it is desirable to satisfy the conditional expression (2). The conditional expression (2) defines a preferred ray height ratio at the telephoto end between axial light rays entering the second lens unit and the second-b lens unit. If the lower limit of the conditional expression (2) is lowered, the axial ray height becomes low, which is advantageous for reducing the decentering sensitivity of the damping lens unit. However, because it is necessary to enhance power of the second-a lens unit, it becomes difficult to correct spherical aberration or coma aberration. On the contrary, if the upper limit of the conditional expression (2) is exceeded, the axial ray height becomes too high, and hence it becomes difficult to suppress the decentering coma aberration when the damping lens unit is decentered. Therefore, by satisfying the conditional expression (2), high aberration performance can be obtained despite of a decentered state of the damping lens unit.

It is more preferred to satisfy the following conditional expression (2a).

0.65<H2b/H2<0.8 (2a)

This conditional expression (2a) defines a more preferable conditional range based on the above-mentioned viewpoint or the like in the conditional range defined by the conditional expression (2). Therefore, it is preferred to satisfy the conditional expression (2a) so that the above-mentioned effect can be more enhanced.

It is desirable to satisfy the following conditional expression (3).

1.0<f2b/f2<4.2 (3)

Here, f2b denotes a focal length of the second-b lens unit, and f2 denotes a focal length of the second lens unit.

In order to suppress the decentering coma aberration in damping vibrations, it is necessary to control the spherical aberration generated by the damping lens unit (namely, the second-b lens unit) itself to be sufficiently small. For this purpose, it is effective to decrease power of the damping lens unit. If the lower limit of the conditional expression (3) is lowered, power of the damping lens unit becomes too strong. Therefore, it becomes difficult to suppress spherical aberration generated in the damping lens unit, and the decentering coma aberration in damping vibrations is increased. If the upper limit of the conditional expression (3) is exceeded, power of the damping lens unit is weakened so that the decentering coma aberration in damping vibrations can be easily suppressed. However, it becomes necessary to enhance power of the second-a lens unit in order to secure power necessary for the entire second lens unit. As a result, it becomes difficult to suppress spherical aberration and coma aberration in a normal condition. Therefore, by satisfying the conditional expression (3), it is possible to obtain high aberration performance despite of the decentered state of the damping lens unit.

It is more preferred to satisfy the following conditional expression (3a).

1.6<f2b/f2<3.6 (3a)

This conditional expression (3a) defines a more preferable conditional range based on the above-mentioned viewpoint or the like in the conditional range defined by the conditional expression (3). Therefore, it is preferred to satisfy the conditional expression (3a) so that the above-mentioned effect can be more enhanced.

It is preferred that the second-a lens unit should include at least one aspheric surface having power that is positive on the optical axis and decreases as being apart from the optical axis. As described above, in order to set power of the second-b lens unit as the damping lens unit to be as small as possible, the second-a lens unit needs strong power. In addition, in order to control the spherical aberration to be small over the entire zoom range, it is necessary to sufficiently suppress spherical aberration of each zoom block and also to control spherical aberration of the entire second lens unit to be sufficiently small. Because the spherical aberration of the second-b lens unit is set to be sufficiently small in order to suppress the decentering coma aberration in damping vibrations, it is necessary to set the spherical aberration of the second-a lens unit to be sufficiently small in order to set the spherical aberration of the entire second lens unit to be small. From this viewpoint, it is desirable to dispose an aspheric surface having positive power decreasing as being apart from the optical axis on at least one surface having positive power on the optical axis disposed in the second-a lens unit.

The second-a lens unit has at least one air interval inside and is split into two lens units with a boundary of an air interval closest to the object side in the second-a lens unit, which include a second-a1 lens unit on the object side and a second-a2 lens unit on the image side. Then, it is desirable that the second-a1 lens unit should have positive power, and the second-a2 lens unit should have negative power. As described above, the second-a lens unit needs to have strong converging action and sufficiently suppress the spherical aberration. Therefore, second-a lens unit is desirable to include the second-a1 lens unit having positive power and the second-a2 lens unit having negative power.

It is desirable to satisfy the following conditional expression (4).

0.5<f2a1/f2<1.5 (4)

Here, f2a1 denotes a focal length of the second-a1 lens unit, and f2 denotes a focal length of the second lens unit.

It is desirable that the focal length of the second-a1 lens unit should satisfy the conditional expression (4). If the lower limit of the conditional expression (4) is lowered, power of the second-a1 lens unit becomes too strong, and hence it becomes difficult to correct spherical aberration or coma aberration. If the upper limit of the conditional expression (4) is exceeded, power of the second-a1 lens unit becomes too weak. Therefore, in order to ensure power necessary for the entire second lens unit, it becomes necessary to enhance power of the second-b lens unit. As a result, it becomes difficult to suppress the decentering coma aberration in damping vibrations. Therefore, by satisfying the conditional expression (4), it is possible to obtain high aberration performance despite of the decentered state of the damping lens unit.

It is desirable that the second-a1 lens unit should be constituted of one positive lens 1 and the second-a2 lens unit should be constituted of one negative lens 1 (corresponding to Examples 1 and 3 described later). It is effective for suppressing spherical aberration of the entire second-a lens unit to constitute the second-a1 lens unit of one positive lens and to constitute the second-a2 lens unit of one negative lens 1. It is possible to effectively suppress the spherical aberration by a simple combination of one positive lens and one negative lens, and the effect thereof is more enhanced by satisfying the conditional expression (4).

It is desirable that the second-a2 lens unit should include at least one aspheric surface having negative power that increases as being apart from the optical axis. By disposing the aspheric surface on the negative lens plane, it is possible to effectively cancel spherical aberration generated on a converging surface (namely, an optical surface having positive power). Therefore, by disposing the aspheric surface having negative power that increases as being apart from the optical axis on the second-a2 lens unit, it is possible to suppress the spherical aberration of the entire second-a lens unit more effectively.

It is desirable that the second-a1 lens unit should be constituted of one positive lens 1, the second-a2 lens unit should be constituted of a cemented lens including a negative lens and a positive lens in this order from the object side, and the following conditional expression (5) is satisfied (corresponding to Example 2 described later).

0.3<ndn−ndp (5)

Here, ndn denotes a refractive index for d-line of a negative lens of the cemented lens, and ndp denotes a refractive index for d-line of a positive lens of the cemented lens.

If the second-a1 lens unit is constituted of one positive lens 1, the second-a2 lens unit is constituted of a cemented lens including a negative lens and a positive lens in this order from the object side, and the conditional expression (5) is satisfied, it is effective for suppressing spherical aberration of the entire second-a lens unit. By satisfying the conditional expression (5), desired spherical aberration can be generated on a cemented surface so that spherical aberration generated on the converging surface (second-a1 lens unit) can be effectively canceled. In addition, it is also possible to correct color aberration in the cemented lens.

It is desirable to perform focusing by moving the third lens unit. In the negative, positive, negative, and positive zoom type, it is possible to achieve lighter weight of the actuator and higher speed of focusing by using the third lens unit as the focus lens unit. In addition, because it is easy to control focus sensitivity of the third lens unit, the third lens unit is preferable as the focus lens unit.

The zoom lens according to the present invention is suitable as an image pickup lens for a digital apparatus with image input function (for example, a digital camera). By combining the zoom lens with an image sensor and the like, it is possible to constitute an imaging optical device for acquiring a subject image in an optical manner so as to output it as an electrical signal. The imaging optical device is an optical device as a main element of a camera used for taking a still image or a moving image of a subject. For instance, the imaging optical device includes, in order from the object (namely, subject) side, a zoom lens forming an optical image of the object, and an image sensor for converting the optical image formed by the zoom lens into an electrical signal. Then, the zoom lens having the above-mentioned characteristic structure is disposed so that an optical image of the subject is formed on a light receiving surface (namely, an imaging surface) of the image sensor. Thus, it is possible to realize a small and inexpensive imaging optical device with high zoom ratio and high performance, and a digital apparatus (for example, a digital camera or a mobile phone) including the imaging optical device.

As examples of a camera, there are a digital camera, a video camera, a monitoring camera, an on-vehicle camera, a videophone camera, and the like. In addition, there are cameras embedded or connected to a personal computer, a digital apparatus (for example, a small and portable information terminal such as a mobile phone or a mobile computer), or to a peripheral device (scanner, printer, or the like), or to other digital apparatuses. As understood from these examples, by using the imaging optical device, a camera can be constituted. In addition, by mounting the imaging optical device in various apparatuses, a camera function can be added. For instance, it is possible to constitute a digital apparatus with image input function such as a mobile phone with camera.

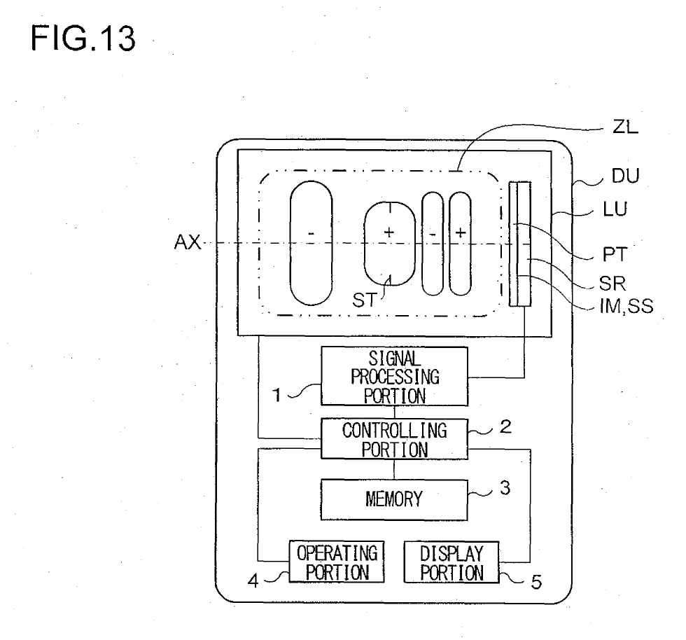

FIG. 13 illustrates a schematic cross section of a general structure example of a digital apparatus DU with image input function. An imaging optical device LU mounted in the digital apparatus DU illustrated in FIG. 13 includes, in order from the object (namely, subject) side, a zoom lens ZL (AX denotes an optical axis, and ST denotes an aperture stop) that forms an optical image (image plane) IM of the object in a magnification variable manner, a parallel flat plate PT (a cover glass of an image sensor SR, which corresponds to an optical filter such as an optical low-pass filter or an infrared cut filter disposed if necessary), and the image sensor SR for converting the optical image IM formed by the zoom lens ZL on a light receiving surface SS into an electrical signal. When the digital apparatus DU with image input function is constituted of the imaging optical device LU, the imaging optical device LU is usually disposed in a body thereof, but it is possible to adopt a form corresponding to necessity for realizing the camera function. For instance, it is possible to adopt a structure in which the imaging optical device LU as a unit can be attached and detached from a main body of the digital apparatus DU or can be rotated with respect to the same.

As the image sensor SR, for example, there is used a solid-state image sensor such as a charge coupled device (CCD) type image sensor or a complementary metal-oxide semiconductor (CMOS) type image sensor, having a plurality of pixels. The zoom lens ZL is disposed so that the optical image IM of the subject is formed on the light receiving surface SS as a photoelectric conversion portion of the image sensor SR. Therefore, the optical image IM formed by the zoom lens ZL is converted by the image sensor SR into an electrical signal.

The digital apparatus DU includes, in addition to the imaging optical device LU, a signal processing portion 1, a controlling portion 2, a memory 3, an operating portion 4, a display portion 5, and the like. The signal processing portion 1 performs predetermined digital image processing, image compression processing, and the like on the signal generated by the image sensor SR as necessity. The processed digital signal as an image signal is recorded in the memory 3 (such as a semiconductor memory, an optical disc, or the like), or sent to other apparatus via a cable or after converted into an infrared signal (for example, by a communication function of a mobile phone). The controlling portion 2 is constituted of a microcomputer and performs integral control such as function control of photographing function (still image photographing function, moving image photographing function, and the like), and image reproducing function, as well as control of a lens moving mechanism for zooming or focusing. For instance, the controlling portion 2 controls the imaging optical device LU so as to perform at least one of the still image photography and the moving image photography of the subject. The display portion 5 is a portion including a display such as a liquid crystal monitor and performs image display using the image signal converted by the image sensor SR or image information recorded in the memory 3. The operating portion 4 is a portion including an operating portion such as an operating button (for example, a release button), an operating dial (for example, a photography mode dial), and transmits the information input by the operator to the controlling portion 2.

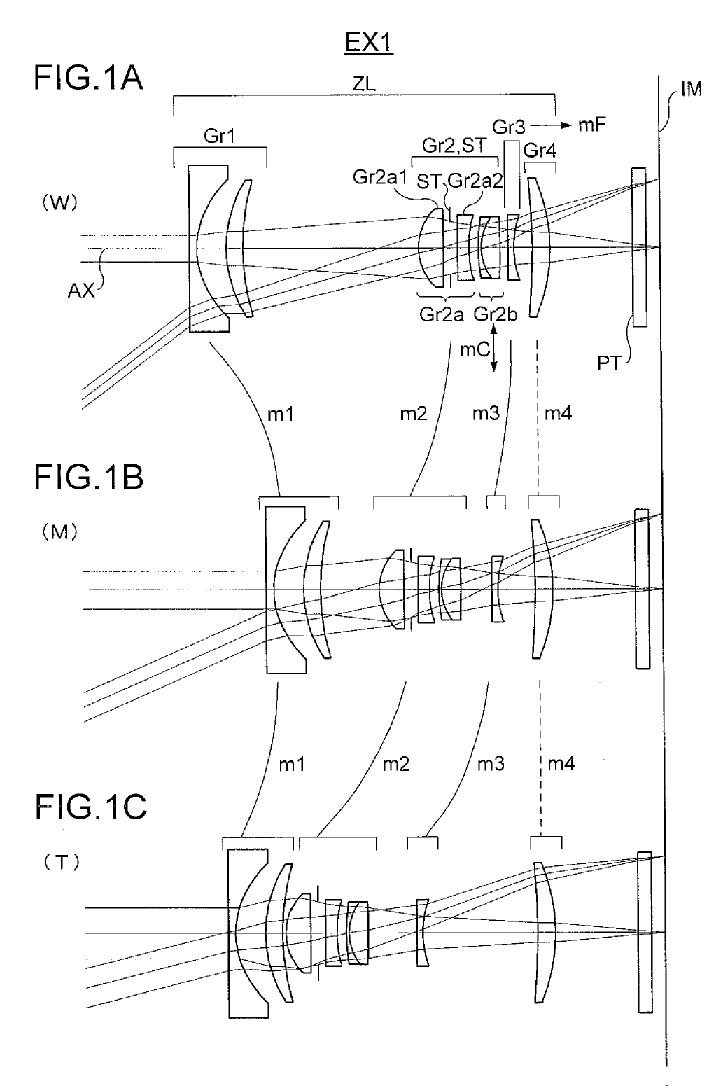

The zoom lens ZL has a zooming structure of negative lead constituted of four lens units including negative, positive, negative, and positive lens units as described above. At least the first lens unit to the third lens unit respectively move along the optical axis AX so as to change intervals between lens units for varying magnification (namely, performing zooming), so that the optical image IM is formed on the light receiving surface SS of the image sensor SR. Here, a specific optical structure of the zoom lens ZL is described in more detail with reference to first to third embodiments. FIGS. 1A to 3C are lens configuration diagrams corresponding to the zoom lenses ZL of the first to the third embodiments, respectively, which illustrate optical cross sections of the lens layout at a wide angle end (W), an intermediate focal length state (M), and a telephoto end (T). The loci m1, m2, m3, and m4 in the lens configuration diagrams schematically illustrate movements of a first lens unit Gr1, a second lens unit Gr2, a third lens unit Gr3, and a fourth lens unit Gr4, respectively, in zooming from the wide angle end (W) to the telephoto end (T) (note that a broken line indicates a fixed zoom position).

In the first embodiment (FIGS. 1A to 1C), the first lens unit Gr1 to the third lens unit Gr3 are moving lens unit, and the fourth lens unit Gr4 is a fixed lens unit. Therefore, the first lens unit Gr1 to the third lens unit Gr3 move for zooming, and the fourth lens unit Gr4 does not move for zooming. The third lens unit Gr3 is a focus lens unit and moves to the image side for focusing to a short distance object as illustrated by arrow mF. The aperture stop ST is disposed in the second lens unit Gr2 and moves together with the second lens unit Gr2 for zooming. A second-b lens unit Gr2b, which is constituted of a cemented lens including a negative fifth lens and a positive sixth lens, is the damping lens unit and moves in the direction perpendicular to the optical axis AX as illustrated by arrow mC so that camera shake correction is performed. The aspheric surface is formed on an image side surface of the first lens, an object side surface of the third lens, an image side surface of the fourth lens, and an image side surface of the seventh lens.

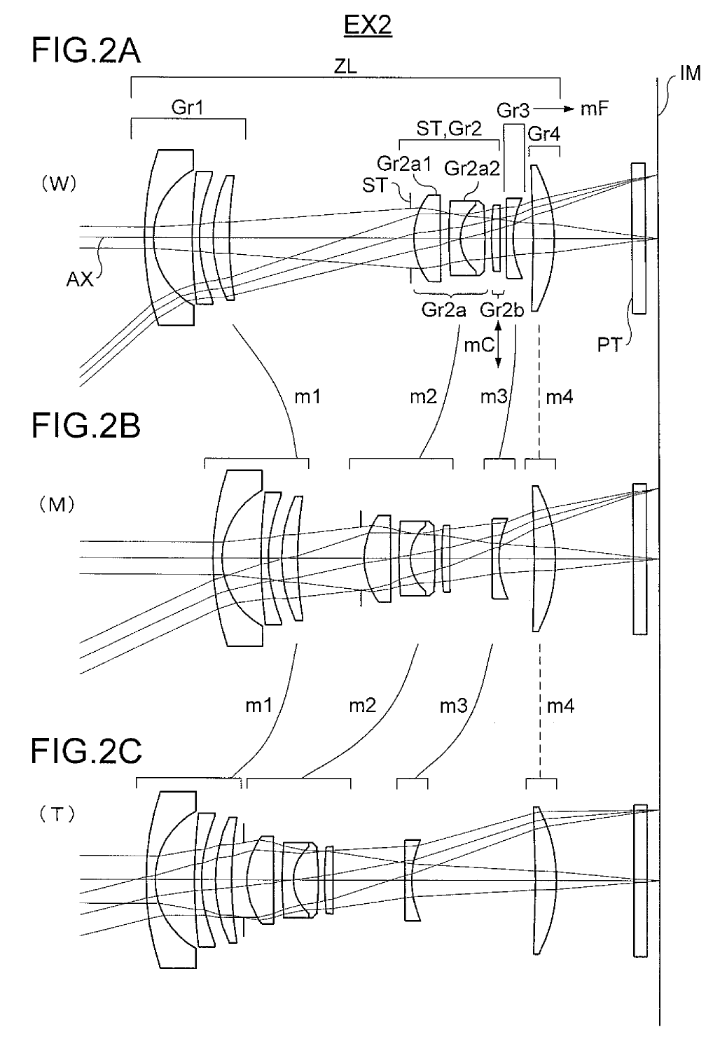

In the second embodiment (FIGS. 2A to 2C), the first lens unit Gr1 to the third lens unit Gr3 are the moving lens units, and the fourth lens unit Gr4 is the fixed lens unit. Therefore, the first lens unit Gr1 to the third lens unit Gr3 move for zooming, and the fourth lens unit Gr4 does not move for zooming. The third lens unit Gr3 is the focus lens unit and moves to the image side for focusing to a short distance object as illustrated by arrow mF. The aperture stop ST is disposed on the object side of the second lens unit Gr2 and moves for zooming together with the second lens unit Gr2. The second-b lens unit Gr2b, which is constituted of the seventh lens, is the damping lens unit and moves in the direction perpendicular to the optical axis AX as illustrated by arrow mC so that the camera shake correction is performed. The aspheric surface is formed on an image side surface of the second lens, both sides of the fourth lens, and an image side surface of the eighth lens.

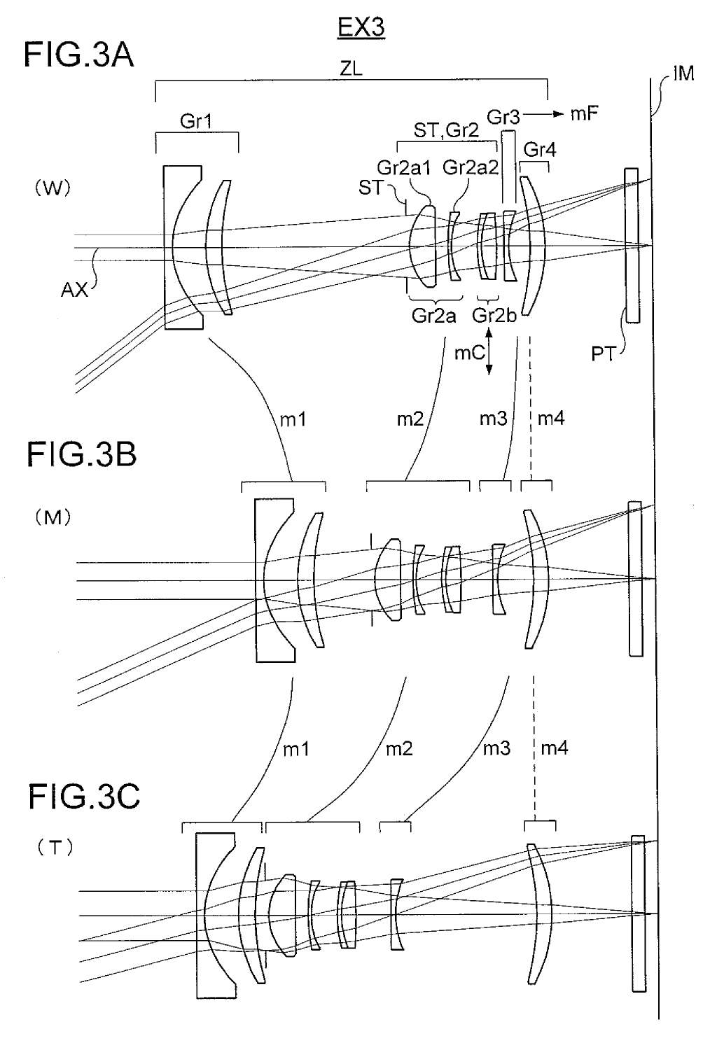

In the third embodiment (FIGS. 3A to 3C), the first lens unit Gr1 to the third lens unit Gr3 are moving lens units, and the fourth lens unit Gr4 is a fixed lens unit. Therefore, the first lens unit Gr1 to the third lens unit Gr3 move for zooming, and the fourth lens unit Gr4 does not move for zooming. The third lens unit Gr3 is a focus lens unit and moves to the image side for focusing to a short distance object as illustrated by arrow mF. The aperture stop ST is disposed on the object side of the second lens unit Gr2 and moves for zooming together with the second lens unit Gr2. The second-b lens unit Gr2b, which is constituted of a cemented lens including a negative fifth lens and a positive sixth lens, is a damping lens unit and moves in the direction perpendicular to the optical axis AX as illustrated by arrow mC so that the camera shake correction is performed. The aspheric surface is formed on an image side surface of the first lens, an object side surface of the third lens, an image side surface of the fourth lens, and an image side surface of the seventh lens.

As understood from the above description, the following structures (S1) to (S13) of the zoom lens, the imaging optical device, and the digital apparatus are included in the embodiments described above.

(S1) A zoom lens including, in order from the object side, a first lens unit having negative power, a second lens unit having positive power, a third lens unit having negative power, and a fourth lens unit having positive power, in which at least the first lens unit to the third lens unit move to change intervals between lens units so that magnification is varied. The second lens unit has at least one air interval inside and is split into two lens units with a boundary of an air interval closest to an image side in the second lens unit, which includes a second-a lens unit on the object side and a second-b lens unit on the image side, and the second-b lens unit is moved in a plane substantially perpendicular to an optical axis for damping vibrations.

(S2) The zoom lens described in the above (S1), in which the following conditional expression (1) is satisfied.

−0.1<β2b<0.8 (1)

Here, β2b denotes a paraxial lateral magnification of the second-b lens unit at a telephoto end.

(S3) The zoom lens described in the above (S1) or (S2), in which the following conditional expression (2) is satisfied.

0.6<H2b/H2<0.85 (2)

Here, H2 denotes an axial ray height in a lens plane closest to the object side in the second lens unit at a telephoto end, and H2b denotes an axial ray height in a lens plane closest to the object side in the second-b lens unit at the telephoto end.

(S4) The zoom lens described in any one of the above (S1) to (S3), in which the following conditional expression (3) is satisfied.

1.0<f2b/f2<4.2 (3)

Here, f2b denotes a focal length of the second-b lens unit, and f2 denotes a focal length of the second lens unit.

(S5) The zoom lens described in any one of the above (S1) to (S4), in which the second-a lens unit has at least one aspheric surface having power that is positive on the optical axis and decreases as being apart from the optical axis.

(S6) The zoom lens described in any one of the above (S1) to (S5), in which the second-a lens unit has at least one air interval inside and is split into two lens units with a boundary of an air interval closest to the object side in the second-a lens unit, which include a second-a1 lens unit on the object side and a second-a2 lens unit on the image side, and the second-a1 lens unit has positive power while the second-a2 lens unit has negative power.

(S7) The zoom lens described in the above (S6), in which the following conditional expression (4) is satisfied.

0.5<f2a1/f2<1.5 (4)

Here, f2a1 denotes a focal length of the second-a1 lens unit, and f2 denotes a focal length of the second lens unit.

(S8) The zoom lens described in the above (S6) or (S7), in which the second-a1 lens unit is constituted of one positive lens, and the second-a2 lens unit is constituted of one negative lens.

(S9) The zoom lens described in the above (S8), in which the second-a2 lens unit has at least one aspheric surface having negative power increasing as being apart from the optical axis.

(S10) The zoom lens described in the above (S6) or (S7), in which the second-a1 lens unit is constituted of one positive lens 1, the second-a2 lens unit is constituted of a cemented lens including a negative lens and a positive lens in this order from the object side, and the following conditional expression (5) is satisfied.

0.3<ndn−ndp (5)

Here, ndn denotes a refractive index of the negative lens of the cemented lens for a d-line, and ndp denotes a refractive index of the positive lens of the cemented lens for the d-line.

(S11) The zoom lens described in any one of the above (S1) to (S10), which is an interchangeable lens for a digital camera.

(S12) An imaging optical device including the zoom lens described in any one of the above (S1) to (S11), and an image sensor for converting an optical image formed on a light receiving surface into an electrical signal, in which the zoom lens is disposed so that the optical image of a subject is formed on the light receiving surface of the image sensor.

(S13) A digital apparatus including the imaging optical device described in the above (S12), so as to have at least one of functions of acquiring a still image and acquiring a moving image of a subject.

According to the zoom lens described in the above (S1), because the second-b lens unit is moved in the plane substantially perpendicular to the optical axis for damping vibrations, it is possible to perform damping vibrations with high accuracy while maintaining high optical performance. Therefore, it is possible to realize the zoom lens having a zoom ratio of approximately three times including a relatively wide angle focal length range with an angle of view (2ω) of 75 degrees or larger in which reduction of the entire optical length and high optical performance in damping vibrations are achieved, and the imaging optical device. Further, by using the high performance compact zoom lens or the imaging optical device for a digital apparatus (for example, a digital camera), it is possible to add high performance image input function to the digital apparatus in a compact manner.

### EXAMPLES

Hereinafter, the structure and the like of the zoom lens to which the present invention is applied is described specifically with reference to construction data of examples. Examples 1 to 3 (EX1 to EX3) described here are numerical examples corresponding to the first to the third embodiments described above, and the optical configuration diagrams (FIGS. 1A to 3C) illustrating the first to the third embodiments illustrate lens structures of corresponding Examples 1 to 3, respectively.

In the construction data of the examples, as surface data, there are in order from the left field, a surface number, a curvature radius r (mm), a surface interval d(mm) on the axis, a refractive index nd for d-line (at a wavelength of 587.56 nm), and Abbe number vd for the d-line. A surfaces of surface number with a symbol “*” is a aspheric surface, and its surface shape is defined by the following expression (AS) using a local rectangular coordinate system (x, y, z) with an origin at a surface vertex. As aspheric surface data, an aspheric coefficient and the like are shown. Note that a coefficient of a term without a note in the aspheric surface data of each example is zero, and “E-n” means “×10⁻ⁿ” in all data.

z=(c·h²)/[1+√{1−(1+K)·c²·h²}]+Σ(Aj·h^{j}) . . . (AS)

Here, h denotes height (h²=x²+y²) in a direction perpendicular to a z axis (optical axis AX), z denotes a sag amount (with reference to the surface vertex) at a position of height h in the direction of the optical axis AX, c denotes a curvature at the surface vertex (reciprocal of the curvature radius r), K denotes a conic constant, and Aj denotes an aspheric coefficient of the j-th order.

As various data, there is shown a zoom ratio, and further as to focal length states (W), (M), and (T), there are shown a focal length (f (mm)) of the entire system, an F number (Fno.), a half angle of view (ω (degrees)), an image height (Y′ (mm)), a total lens length (TL (mm)), a back focus (BF (mm)), and a variable surface interval di (nun, where i is the surface number). As zoom lens unit data, there are shown focal lengths (mm) of the lens units. Here, BF used here is distance from the image side surface of the cover glass (corresponding to the parallel flat plate PT) to the image plane, and the total lens length is a distance from the frontmost surface of the lens to the image plane. In addition, Table 1 shows conditional expression corresponding values and the relevant data for each example.

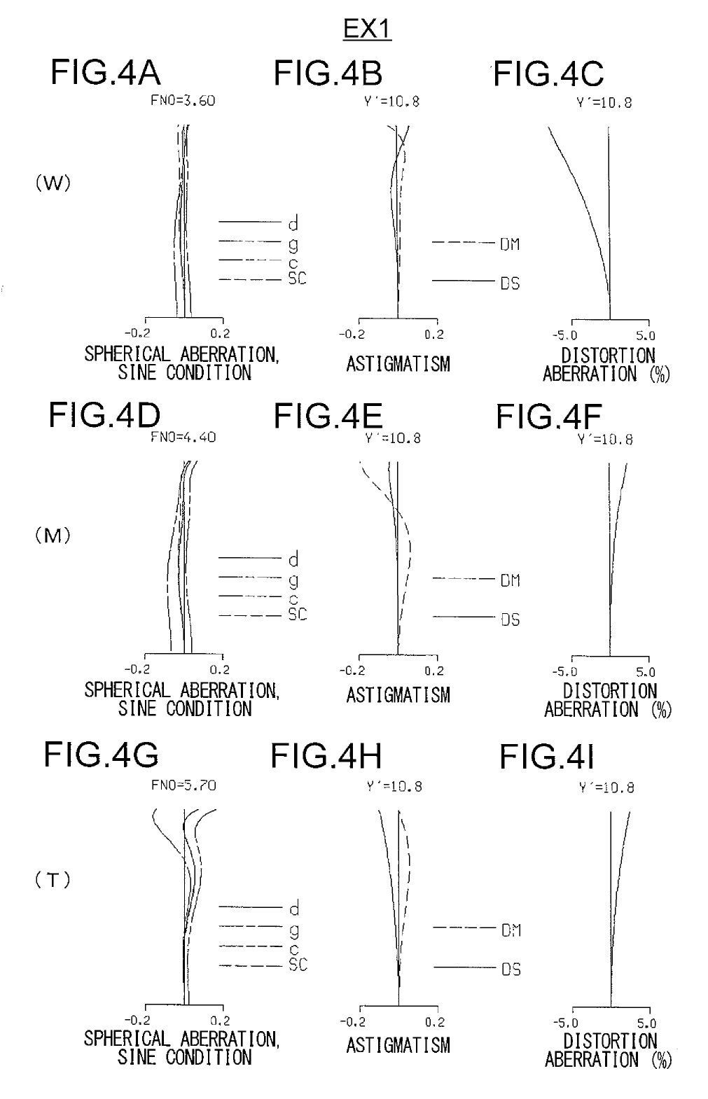

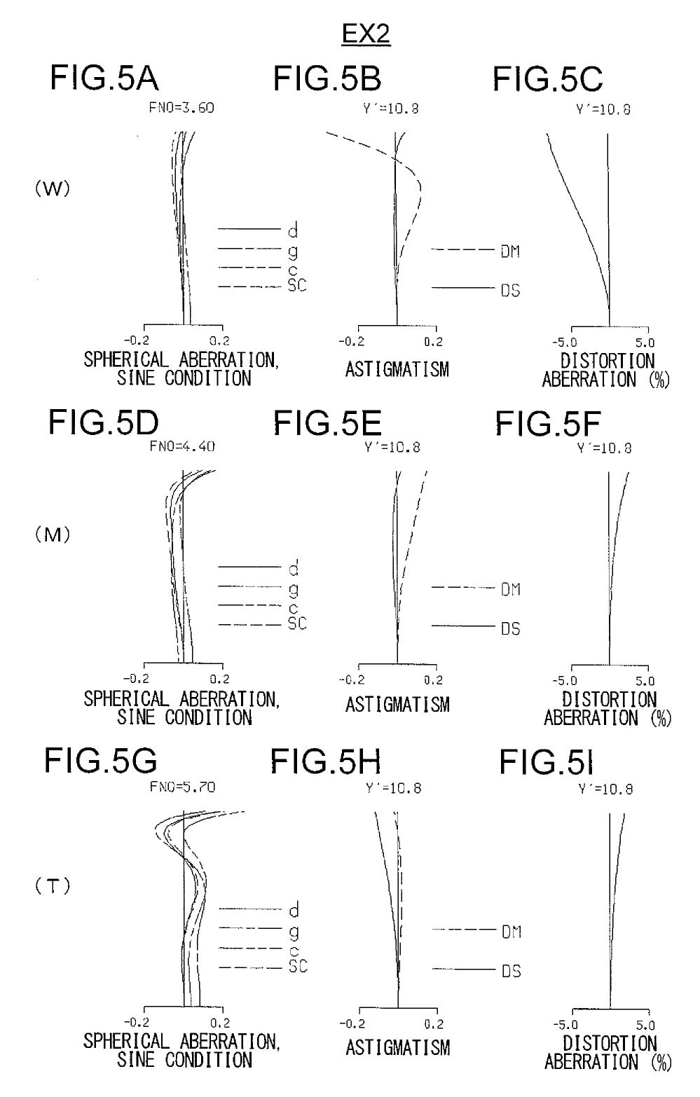

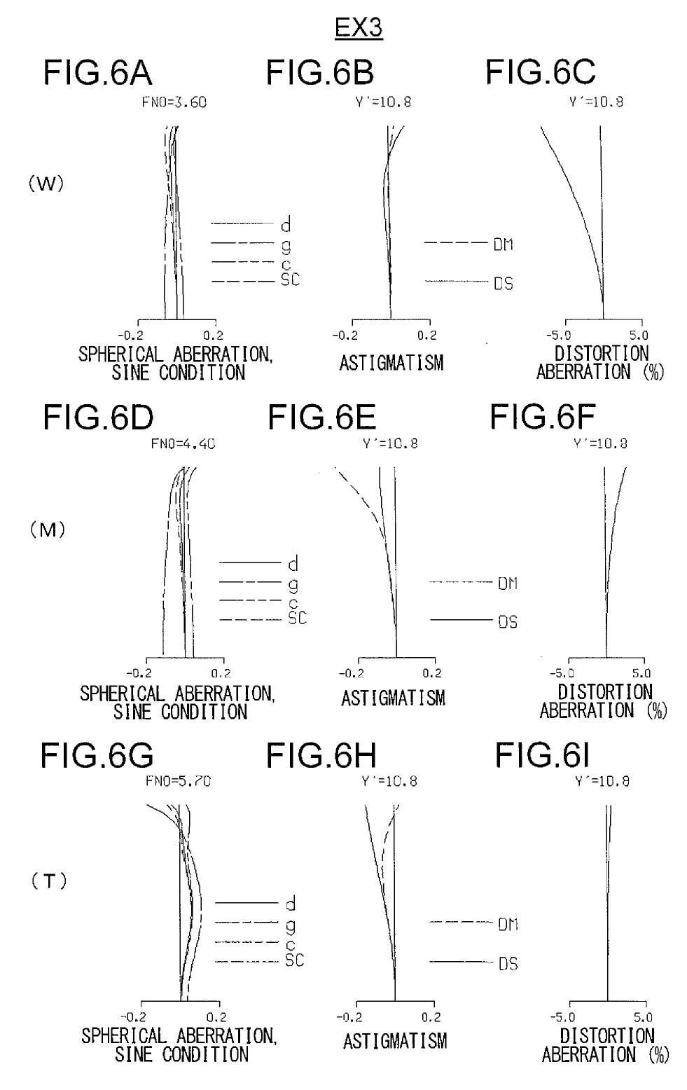

FIGS. 4A to 6I are aberration diagrams (vertical aberration diagrams in the normal condition (before decentering), and in a state focused at infinity) corresponding to Examples 1 to 3 (EX1 to EX3), in which (W) indicates aberrations at the wide angle end, (M) indicates aberrations at the intermediate position, and (T) indicates aberrations at the telephoto end (including in order from the left, spherical aberration, astigmatism, and distortion aberration). In FIGS. 4A to 6I, FNO denotes the F number, Y′ (mm) denotes a largest image height (corresponding to a distance from the optical axis AX) on the light receiving surface SS of the image sensor SR. In the spherical aberration diagram, solid line d, dashed dotted line g, and double dot dashed line c indicate spherical aberrations (mm) for d-line, g-line, and c-line, and broken line SC indicates a sine condition unsatisfying amount (mm). In the astigmatism diagram, broken line DM illustrates astigmatism (mm) for the d-line on a meridional surface, and solid line DS illustrates the same on a sagittal surface. In addition, in the distortion aberration diagram, a solid line illustrates distortion (%) for the d-line.

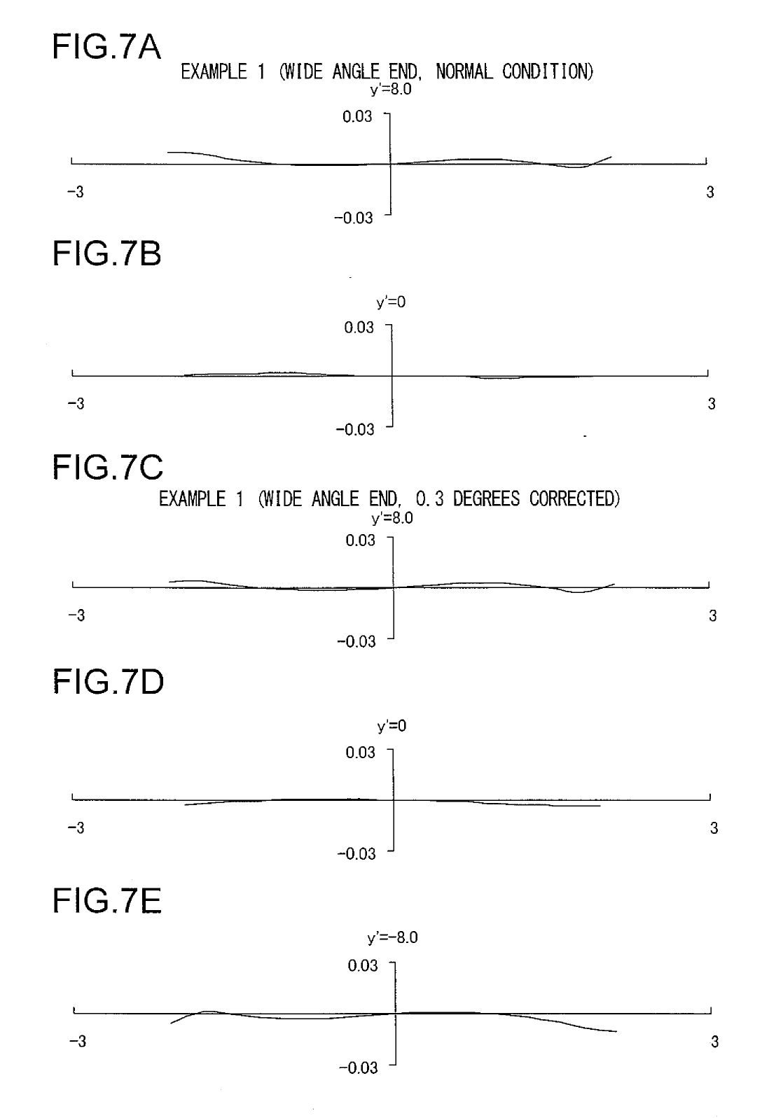

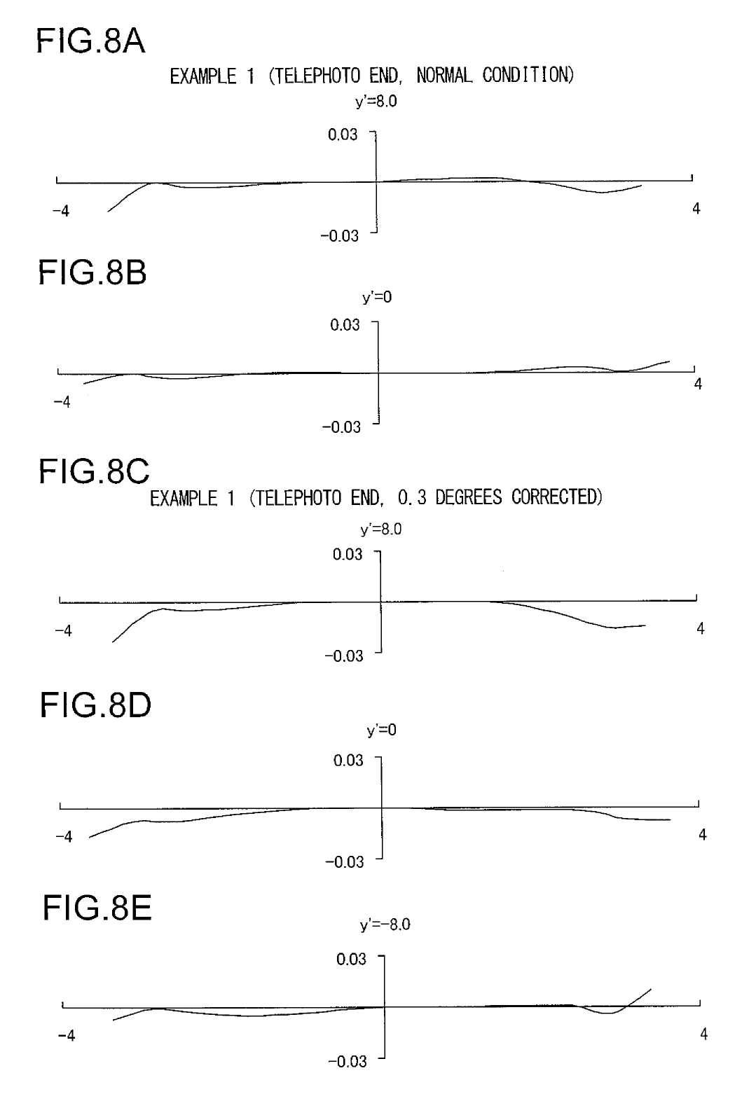

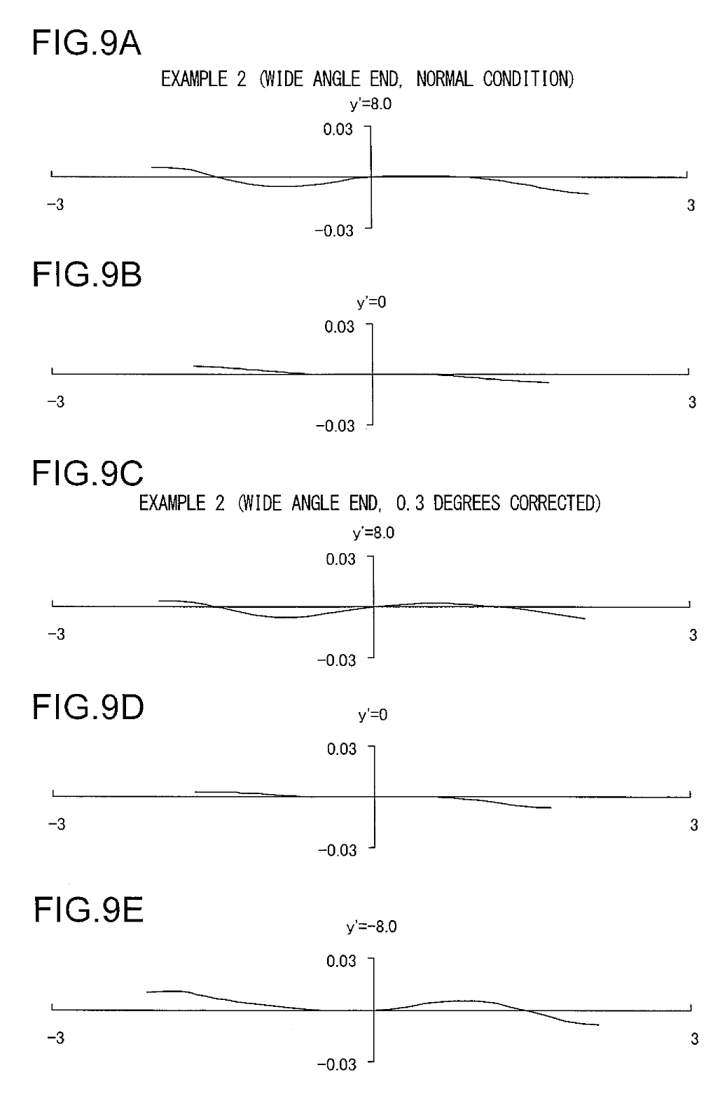

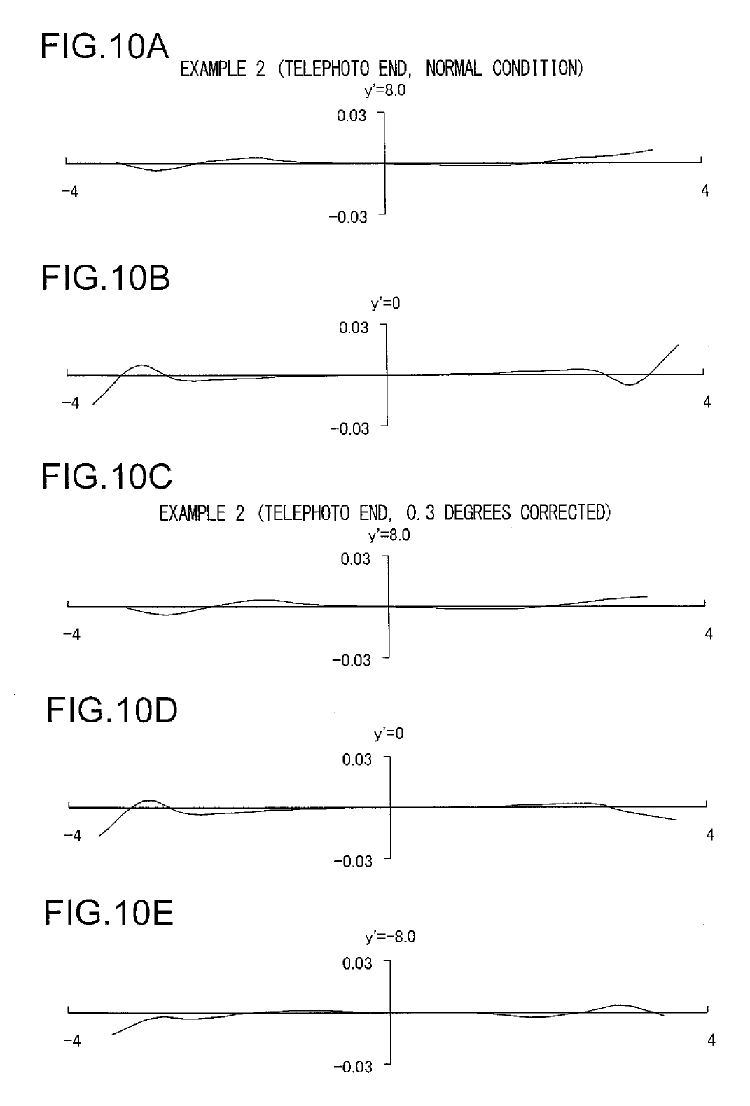

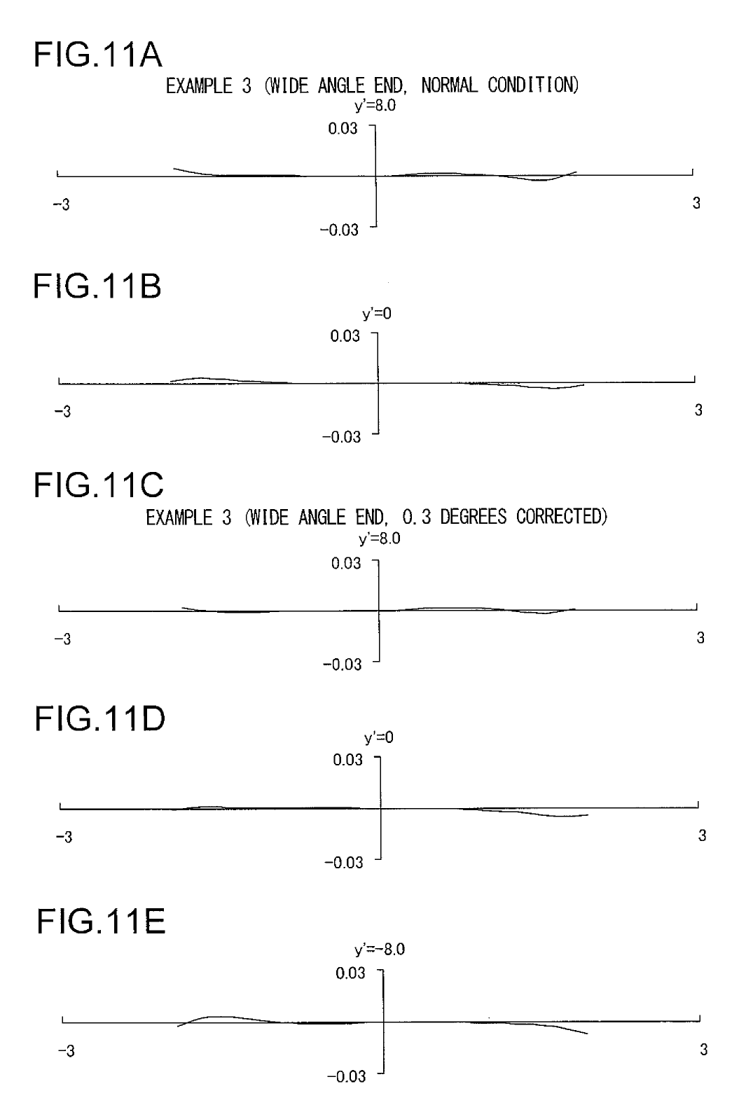

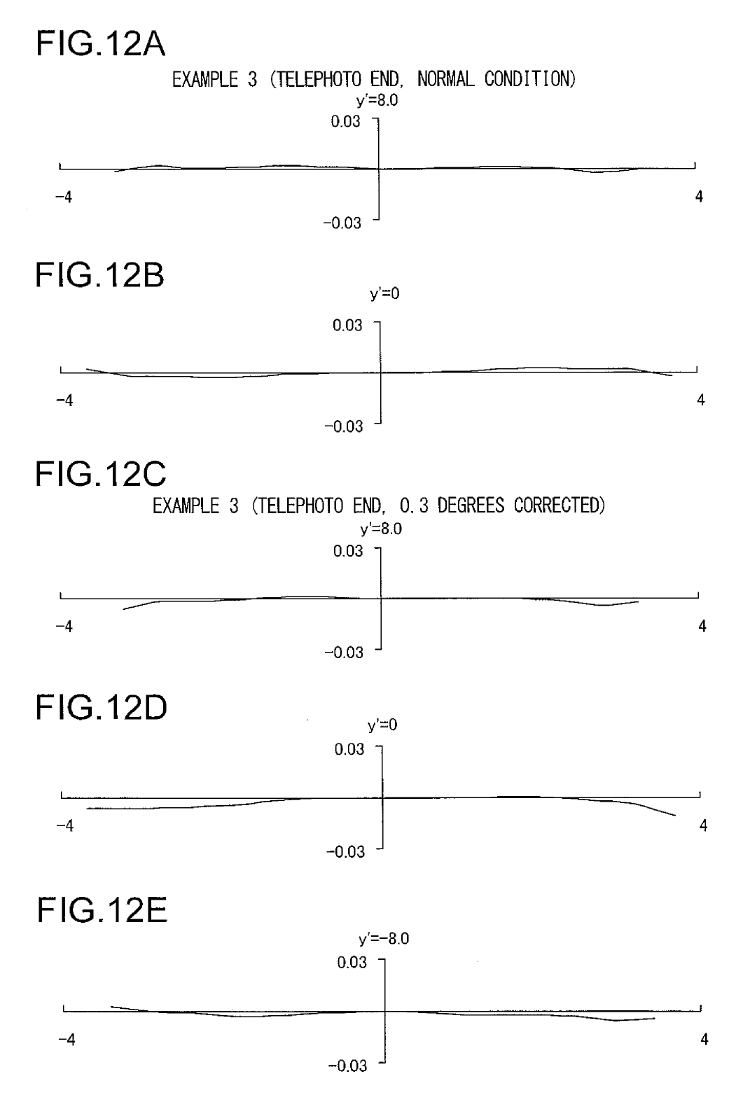

FIGS. 7A to 12E are lateral aberration diagrams of Examples 1 to 3 (EX1 to EX3) before decentering (in the normal condition) and after decentering (after the camera shake correction), in the state focused at infinity. FIGS. 7A to 8E correspond to Example 1, FIGS. 9A to 10E correspond to Example 2, and FIGS. 11A to 12E correspond to Example 3. In FIGS. 7A to 12E, (A) and (B) are lateral aberration diagrams before decentering, (C) to (E) are lateral aberration diagrams after decentering (y′(mm) corresponds to an image height on the light receiving surface SS of the image sensor SR (a distance from the optical axis AX). FIGS. 7A to 7E, FIGS. 9A to 9E, and FIGS. 11A to 11E illustrate deteriorations of axial and off-axial lateral aberrations when an image blur of an angle 0.3 degrees at the wide angle end (W) is corrected by decentering of a decentering lens component (namely, the second-b lens unit (damping lens unit) Gr2b). FIGS. 8A to 8E, FIGS. 10A to 10E, and FIGS. 12A to 12E illustrate deteriorations of axial and off-axial lateral aberrations when an image blur of an angle 0.3 degrees at the telephoto end (T) is corrected by decentering of the decentering lens component.

### Example 1

Unit: mm
Surface data

| Surface number | r | d | nd | vd |
|---|---|---|---|---|
| 1 | 539.632 | 1.190 | 1.80420 | 46.49 |
| 2* | 12.159 | 4.331 | | |
| 3 | 18.835 | 2.430 | 1.84666 | 23.78 |
| 4 | 34.946 | variable | | |
| 5* | 7.853 | 3.600 | 1.49700 | 81.61 |
| 6 | 342.062 | 1.045 | | |
| 7(stop) | ∞ | 1.000 | | |
| 8 | 200.290 | 1.740 | 1.83441 | 37.28 |
| 9* | 24.028 | 1.344 | | |
| 10 | 28.169 | 0.400 | 1.62004 | 36.30 |
| 11 | 7.280 | 2.860 | 1.63854 | 55.43 |
| 12 | −91.514 | variable | | |
| 13 | −149.072 | 0.800 | 1.53048 | 55.72 |
| 14* | 14.199 | variable | | |
| 15 | −96.170 | 2.560 | 1.80420 | 46.49 |
| 16 | −26.897 | 12.100 | | |
| 17 | ∞ | 2.000 | 1.51680 | 64.20 |
| 18 | ∞ | BF | | |

Aspheric surface data

Second surface
K = 0.00000
A4 = −3.35989E−05
A6 = −3.84200E−07
A8 = 2.55853E−09
A10 = −2.96843E−11
Fifth surface
K = 0.00000
A4 = −1.44451E−05
A6 = −6.27159E−07
A8 = 2.62746E−08
A10 = −4.40636E−10
Ninth surface
K = 0.00000
A4 = 3.44172E−04
A6 = 6.47376E−06
A8 = −3.89285E−08
A10 = 1.01322E−08
Fourteenth surface
K = 0.00000
A4 = 2.30309E−05
A6 = −7.37430E−07
A8 = 5.67158E−08
A10 = 1.24925E−09

Various data
Zoom ratio 3.000

| | Wide angle | Intermediate | Telephoto |
|---|---|---|---|
| | (W) | (M) | (T) |
| Focal length | 14.000 | 24.200 | 41.999 |
| F number | 3.600 | 4.400 | 5.700 |
| Half angle of view | 39.932 | 23.577 | 14.094 |
| Image height | 10.800 | 10.800 | 10.800 |
| Total lens length | 68.870 | 58.000 | 63.858 |
| BF | 2.000 | 2.000 | 1.999 |
| d4 | 25.602 | 8.550 | 0.500 |
| d12 | 1.163 | 4.597 | 7.145 |
| d14 | 2.706 | 5.453 | 16.813 |

Zoom lens unit data

| Unit | Start surface | Focal length |
|---|---|---|
| 1 | 1 | −26.099 |
| 2 | 5 | 16.572 |
| 3 | 13 | −24.397 |
| 4 | 15 | 45.679 |

### Example 2

Unit: mm
Surface data

| Surface number | r | d | nd | vd |
|---|---|---|---|---|
| 1 | 43.454 | 1.400 | 1.72916 | 54.66 |
| 2 | 12.166 | 6.033 | | |
| 3 | 86.816 | 1.100 | 1.83481 | 42.72 |
| 4* | 21.885 | 2.084 | | |
| 5 | 22.902 | 2.500 | 1.84666 | 23.78 |
| 6 | 58.836 | variable | | |
| 7(stop) | ∞ | 0.500 | | |
| 8* | 10.919 | 4.100 | 1.77377 | 47.18 |
| 9* | −314.096 | 1.317 | | |
| 10 | 62.572 | 1.740 | 1.90366 | 31.31 |
| 11 | 6.700 | 3.850 | 1.49700 | 81.61 |
| 12 | −78.786 | 1.000 | | |
| 13 | 44.573 | 1.300 | 1.84666 | 23.78 |
| 14 | 507.123 | variable | | |
| 15 | 507.123 | 1.100 | 1.53048 | 55.72 |
| 16* | 14.924 | variable | | |
| 17 | −221.628 | 3.350 | 1.62299 | 58.11 |
| 18 | −24.743 | 12.100 | | |
| 19 | ∞ | 2.000 | 1.51680 | 64.20 |
| 20 | ∞ | BF | | |

Aspheric surface data

Fourth surface
K = 0.00000
A4 = −2.29360E−05
A6 = −1.02931E−07
A8 = 2.31746E−10
A10 = −5.64920E−12
Eighth surface
K = 0.00000
A4 = −3.73493E−05
A6 = 3.56228E−07
A8 = −1.57672E−08
A10 = 1.43557E−10
Ninth surface
K = 0.00000
A4 = 3.36398E−05
A6 = 9.43525E−07
A8 = −3.57707E−08
A10 = 4.42346E−10
Sixteenth surface
K = 0.00000
A4 = 4.15552E−05
A6 = −7.78732E−07
A8 = 9.35178E−09
A10 = −2.62548E−10

Various data
Zoom ratio 3.500

| | Wide angle | Intermediate | Telephoto |
|---|---|---|---|
| | (W) | (M) | (T) |
| Focal length | 12.000 | 22.400 | 42.000 |
| F number | 3.600 | 4.400 | 5.700 |
| Half angle of view | 44.361 | 25.175 | 14.166 |
| Image height | 10.800 | 10.800 | 10.800 |
| Total lens length | 80.000 | 69.483 | 79.811 |
| BF | 2.000 | 2.000 | 2.000 |
| d6 | 28.354 | 9.899 | 1.865 |
| d14 | 1.000 | 6.544 | 11.230 |
| d16 | 3.172 | 5.566 | 19.242 |

Zoom lens unit data

| Unit | Start surface | Focal length |
|---|---|---|
| 1 | 1 | −21.356 |
| 2 | 7 | 17.975 |
| 3 | 15 | −29.009 |
| 4 | 17 | 44.418 |

### Example 3

Unit: mm
Surface data

| Surface number | r | d | nd | vd |
|---|---|---|---|---|
| 1 | 1429.665 | 1.250 | 1.80420 | 46.49 |
| 2* | 12.550 | 5.002 | | |
| 3 | 19.604 | 2.400 | 1.84666 | 23.78 |
| 4 | 35.288 | variable | | |
| 5(stop) | ∞ | 0.500 | | |
| 6* | 8.379 | 4.000 | 1.49700 | 81.61 |
| 7 | −217.375 | 1.773 | | |
| 8 | 27.930 | 0.500 | 1.67270 | 32.17 |
| 9* | 13.051 | 3.800 | | |
| 10 | 19.563 | 0.600 | 1.64769 | 33.84 |
| 11 | 12.655 | 2.290 | 1.49700 | 81.61 |
| 12 | −65.404 | variable | | |
| 13 | 150.745 | 0.800 | 1.53048 | 55.72 |
| 14* | 12.449 | variable | | |
| 15 | −39.062 | 2.270 | 1.80420 | 46.49 |
| 16 | −21.738 | 12.100 | | |
| 17 | ∞ | 2.000 | 1.51680 | 64.20 |
| 18 | ∞ | BF | | |

Aspheric surface data
Second surface

K = 0.00000
A4 = −3.14807E−05
A6 = −2.93044E−07
A8 = 1.39119E−09
A10 = −1.90131E−11
Sixth surface
K = 0.00000
A4 = −1.79356E−05
A6 = −7.18301E−07
A8 = 1.19309E−08
A10 = −3.82123E−10
Ninth surface
K = 0.00000
A4 = 3.21205E−04
A6 = 4.60161E−06
A8 = 4.56187E−08
A10 = 4.51866E−09
Fourteenth surface
K = 0.00000
A4 = 1.59657E−05
A6 = −7.72935E−07
A8 = −1.29370E−08
A10 = −4.05302E−11

Various data
Zoom ratio 3.000

| | Wide angle | Intermediate | Telephoto |
|---|---|---|---|
| | (W) | (M) | (T) |
| Focal length | 14.000 | 24.200 | 42.000 |
| F number | 3.600 | 4.400 | 5.700 |
| Half angle of view | 39.939 | 23.477 | 14.345 |
| Image height | 10.800 | 10.800 | 10.800 |
| Total lens length | 73.108 | 60.000 | 69.074 |
| BF | 2.000 | 2.000 | 2.000 |
| d4 | 27.575 | 8.692 | 1.500 |
| d12 | 1.000 | 4.607 | 5.180 |
| d14 | 3.248 | 5.416 | 21.109 |

Zoom lens unit data

| Unit | Start surface | Focal length |
|---|---|---|
| 1 | 1 | −26.032 |
| 2 | 5 | 17.365 |
| 3 | 13 | −25.632 |
| 4 | 15 | 57.587 |

TABLE 1
conditional expression corresponding values
Example 1

| CONDITIONAL | | | | |
|---|---|---|---|---|
| EXPRESSION | | | | |
| CORRESPONDING | | | | |
| VALUES | | EXAMPLE 1 | EXAMPLE 2 | EXAMPLE 3 |
| βr | | 1.804 | 1.670 | 2.004 |
| H2 | | 5.147 | 6.209 | 5.530 |
| H2b | | 3.889 | 4.454 | 4.113 |
| f2 | | 16.572 | 17.974 | 17.365 |
| f2a | | 23.715 | 21.362 | 23.624 |
| f2b | | 32.072 | 57.645 | 34.961 |
| f2a1 | | 16.114 | 13.713 | 16.329 |
| f2a2 | | −32.870 | −25.981 | −36.917 |
| (1) | β2b | 0.238 | 0.474 | 0.335 |
| (2) | H2b/H2 | 0.755 | 0.717 | 0.744 |
| (3) | f2b/f2 | 1.935 | 3.207 | 2.013 |
| (4) | f2a1/f2 | 0.972 | 0.763 | 0.940 |
| (5) | ndn − ndp | — | 0.407 | — |

What is claimed is:

1. A zoom lens comprising:
a first lens unit having negative power;
a second lens unit having positive power;
a third lens unit having negative power; and
a fourth lens unit having positive power, wherein
the first lens unit, the second lens unit, the third lens unit, and the fourth lens unit are disposed in this order from an object side,
at least the first lens unit to the third lens unit move to change intervals between lens units so that magnification is varied,
the second lens unit has at least one air interval inside and is split into two lens units with a boundary of an air interval closest to an image side in the second lens unit, which includes a second-a lens unit on the object side and a second-b lens unit on the image side, and
the second-b lens unit is moved in a plane substantially perpendicular to an optical axis for damping vibrations.

2. The zoom lens according to claim 1, satisfying the following conditional expression (1):
−0.1<β2b<0.8 (1),
where, β2b denotes a paraxial lateral magnification of the second-b lens unit at a telephoto end.

3. The zoom lens according to claim 1, satisfying the following conditional expression (2):
0.6<H2b/H2<0.85 (2),
where, H2 denotes an axial ray height in a lens plane closest to the object side in the second lens unit at a telephoto end, and H2b denotes an axial ray height in a lens plane closest to the object side in the second-b lens unit at the telephoto end.

4. The zoom lens according to claim 1, satisfying the following conditional expression (3):
1.0<f2b/f2<4.2 (3),
where, f2b denotes a focal length of the second-b lens unit, and f2 denotes a focal length of the second lens unit.

5. The zoom lens according to claim 1, wherein the second-a lens unit has at least one aspheric surface having power that is positive on the optical axis and decreases as being apart from the optical axis.

6. The zoom lens according to claim 1, wherein the second-a lens unit has at least one air interval inside and is split into two lens units with a boundary of an air interval closest to the object side in the second-a lens unit, which include a second-a1 lens unit on the object side and a second-a2 lens unit on the image side, and the second-a1 lens unit has positive power while the second-a2 lens unit has negative power.

7. The zoom lens according to claim 6, satisfying the following conditional expression (4):
0.5<f2a1/f2<1.5 (4),
where, f2a1 denotes a focal length of the second-a1 lens unit, and f2 denotes a focal length of the second lens unit.

8. The zoom lens according to claim 6, wherein the second-a1 lens unit is constituted of a single positive lens, and the second-a2 lens unit is constituted of a single negative lens.

9. The zoom lens according to claim 8, wherein the second-a2 lens unit has at least one aspheric surface having negative power increasing as being apart from the optical axis.

10. The zoom lens according to claim 6, wherein the second-a1 lens unit is constituted of one positive lens 1, the second-a2 lens unit is constituted of a cemented lens including a negative lens and a positive lens in this order from the object side, and the following conditional expression (5) is satisfied:
0.3<ndn−ndp (5),
where ndn denotes a refractive index of the negative lens of the cemented lens for a d-line, and ndp denotes a refractive index of the positive lens of the cemented lens for the d-line.

11. The zoom lens according to claim 1, which is an interchangeable lens for a digital camera.

12. An imaging optical device comprising:
the zoom lens according to claim 1; and
an image sensor for converting an optical image formed on a light receiving surface into an electrical signal, wherein
the zoom lens is disposed so that the optical image of a subject is formed on the light receiving surface of the image sensor.

13. A digital apparatus comprising the imaging optical device according to claim 12, so as to have at least one of functions of acquiring a still image and acquiring a moving image of a subject.
